(19) United States
(12) Patent Application Publication
(10) Pub. No.: US 2024/0039871 A1
(43) Pub. Date: Feb. 1, 2024

(54) FIRST BURST EMULATOR IN A NETWORK SWITCH

(71) Applicant: Cisco Technology, Inc., San Jose, CA (US)

(72) Inventor: Harsha BHARADWAJ, Bangalore (IN)

(21) Appl. No.: 17/816,209

(22) Filed: Jul. 29, 2022

(51) Int. Cl. H04L 49/55; H04L 49/103; H04L 67/1097

(52) U.S. Cl. CPC H04L 49/555; H04L 49/103; H04L 67/1097

(57) ABSTRACT

First Burst (FB) emulation for a FB enabled host at a network switch is described. The FB write operation is an accelerated write input/output (I/O) method for fibre channel non-volatile memory express (NVMe) (FC-NVMe) traffic that reduces a number of communication phases between a host point and storage point. In some examples, a storage system connected to the FB enabled host, via the network switch, is not FB enabled. In this example, the network switch initiates a FB emulation to provide FB functions to the FB enabled host. The FB emulation at the network switch stores FB data from the host as emulated data at the network switch and then transfers the emulated data to the connected storage system using standard write I/O operations.

### TECHNICAL FIELD

Embodiments presented in this disclosure generally relate to a network switch which provides for improved storage system access in a network. More specifically, embodiments disclosed herein provide for first burst emulation at a network switch, which enables first burst communication between a host device and a storage system, where the storage system is not able to interact with first burst communication.

### BACKGROUND

Modern applications and computing devices increasingly rely on distributed computing systems to execute various application functions. These distributed computing systems may be formed on networks that are distributed among multiple different hardware components (e.g., distributed servers) and across multiple geographic locations (e.g., across geographically dispersed data centers, etc.). For some applications and devices, fast and reliable communication is required for the operations of the applications to function properly. In turn, network operators offer no-drop or lossless network protocols such as fibre channel (FC), which enables ordered and lossless data transfers between host points and storage points in a FC fabric (network).

Example data transfers include flash based operations, such as FC-non-volatile memory express (NVMe) write operations. These flash based operations to flash based media in a storage system, are generally processed and stored in memory much faster than previous operations to hard disk drives (HDDs)). For example, in some flash based operations, a write operation often completes in range of 100-200 microseconds (μs). In contrast, standard (or non-flash) write operations over a FC fabric add a latency penalty for each input/output (I/O) operation due to round trip times (RTTs) of multiple communication frames or information units (11.1s). This latency may add a significant overhead for applications operating on the FC fabric that heavily utilize write operations.

To address the latency issues, newer communication protocols provide methods to reduce RTTs and overall latency for FC I/O operations. For example, the FC-NVMe standard includes a First Burst (FB) write operation. The FB write operation is an accelerated write I/O method for FC-NVMe traffic that reduces a number of communication phases between a host point and storage point, and saves at least one RTT time for each write operation. However, while host applications and devices can easily implement and utilize FB operations, associated storage systems require more complicated updates in order to implement the reception of FB write operations. Providing a means to allow for FB write operations to legacy storage systems in a FC network remains a challenge.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a network, according to one embodiment.

FIG. 2A illustrates a system flow diagram for emulating FB operations, according to one embodiment.

FIG. 2B illustrates a system flow block diagram for emulating FB operations, according to one embodiment.

FIG. 3 illustrates a system flow diagram for emulating FB operations, according to one embodiment.

FIG. 4 is a method for emulating FB operations, according to one embodiment.

FIG. 5 is a method for pausing emulated FB operations, according to one embodiment.

FIG. 6 is a method for pausing emulated FB operations, according to one embodiment.

FIG. 7 illustrates a block diagram of a network switch, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method performed at a network switch. The method includes determining, at a network switch, a connected host, connected to the network switch, is a first burst (FB) capable network device and establishing an FB emulation for the connected host at the network switch upon determining a connected storage system, connected to the network switch, is not FB capable. The method also includes receiving a FB operation that includes a FB write frame and FB data from the connected host destined to the connected storage system and storing the FB data as emulated data at the network switch. The method also includes transferring the emulated data to the connected storage system and indicating a completion of the FB operation to the connected host. Other embodiments of this aspect include corresponding computer systems, apparatus, and computer programs recorded on one or more computer storage devices, each configured to perform the actions of the methods.

One example embodiment includes a system. The system includes a processor and a memory that include instructions which, when executed on the processor, performs an operation. The operation includes: determining, at a network switch, a connected host is a first burst (FB) capable network device, establishing an FB emulation for the connected host at the network switch upon determining a connected storage system, connected to the network switch, is not FB capable, and receiving a FB operation which includes a FB write frame and FB data from the connected host. The operation also includes storing the FB data as emulated data at the network switch, transferring the emulated data to the connected storage system, and indicating a completion of the FB operation to the connected host.

One example embodiment includes a computer program product which includes a non-transitory computer-readable medium having program instructions embodied therewith. The program instructions are executable by a processor to perform an operation. The operation includes determining, at a network switch, a connected host is a first burst (FB) capable network device, establishing an FB emulation for the connected host at the network switch upon determining a connected storage system, connected to the network switch, is not FB capable, and receiving a FB operation that includes a FB write frame and FB data from the connected host. The operation also includes storing the FB data as emulated data at the network switch, transferring the emulated data to the connected storage system, and indicating a completion of the FB operation to the connected host.

### Example Embodiments

As described above, distributed computing systems rely on lossless and fast networks to perform various application functions. One example network is a FC fabric where each of the connected devices, including switches, hosts, and storage systems include I/O ports for communication. In order to provide lossless communication in the FC fabric, the I/O ports utilize a standard set of I/O operations that include a command phase/sequence, a data phase/sequence, and a response phase/sequence. Additionally, the FC fabric also provides for accelerated write I/O operations to provide for fast write operations to available flash storage in the respective storage systems.

For example, the FC-NVMe standard includes FB write operational capabilities. In some examples, the FB write operation is an accelerated write I/O method for FC-NVMe (i.e. flash storage) traffic that eliminates at least one phase from the standard write I/O operation described above. The elimination of the at least one phase saves at least one RTT time for each write operation and reduces overall latency for the host in the FC fabric.

In some examples, the host points or devices in a FC fabric are easily updated to enable FB I/O operations at the host. For example, host bus adapter (HBA) vendors/manufacturers for the host devices, may implement FB I/O operations in software. For example, a FC driver of a host storage stack may be updated to enable FB write operations along with setting burst sizes for the FB write operation.

In contrast, corresponding storage systems often do not yet support FB write operations. For example, many storage system vendors/manufacturers enable I/O processing in custom circuitry (e.g., custom application-specific integrated circuit ASICs or Field-programmable gate arrays (FPGAs)). In turn, updating the storage systems to support the FB operations often requires changing/altering the underlying hardware architectures of the storage systems. Moreover, even as FB support is added to storage systems, network operators or storage system operators may delay upgrading storage systems to the newer product architectures that support FB, until the storage system reaches an end of its operational life. The resulting mismatch of FB capabilities causes delayed implementation of accelerated I/O operations.

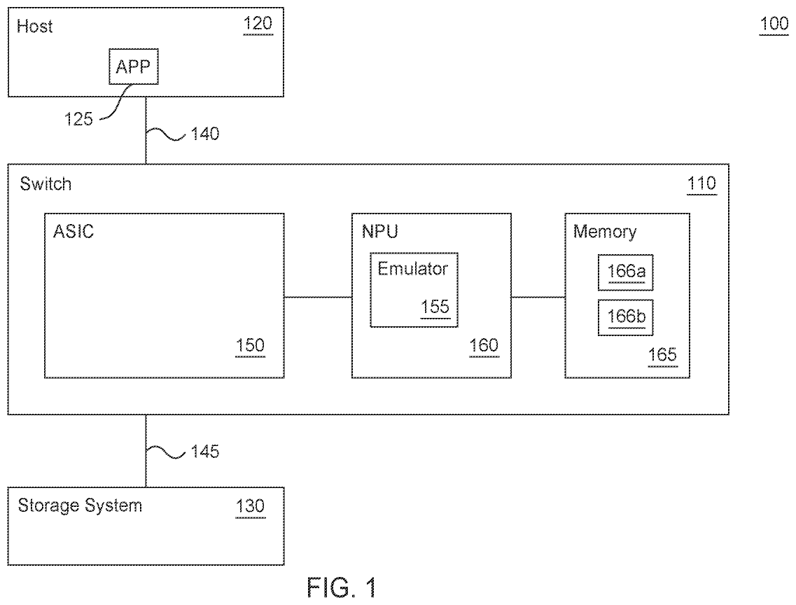

The systems and methods described herein establish an FB emulation for a FB enabled host at a network switch, when a connected storage system is not FB enabled. The emulator at the network switch stores FB data from the host as emulated data at the network switch and then transfers the emulated data to the connected storage system using standard write I/O operations. The FB enabled host, storage system, and network switch are described in more detail in relation to FIG. 1.

FIG. 1 illustrates a network 100, according to one embodiment. The network 100 includes a switch 110, a host 120, and a storage system 130. In some examples, the network 100 is a FC fabric which provides lossless data transfers between the host 120 and the storage system 130. The host 120 is a host point in a FC fabric hosting an application 125 and is connected to the switch 110 via connection 140. The switch 110 is also connected to the storage system 130 via connection 145, where the storage system 130 is a storage point in the FC fabric.

For ease of illustration, the connections 140 and 145 are shown as direct connections; however, the connections 140 and 145 may include multiple hops between the illustrated devices. For example, the connections 140 and 145 may include several additional switches or other networked devices which provide the connections. Additionally, while shown as single points in FIG. 1, the host 120 and the storage system 130 may include multiple hardware components functioning together as the single point.

For ease of discussion, the network 100 is described as a FC fabric; however, the various methods, operations, systems, etc. described herein may be implemented in any type of computing network which utilizes lossless and fast data transfer. In a FC fabric such as the network 100, each of the devices, including the switch 110, the host 120, and the storage system 130 include I/O ports for communication.

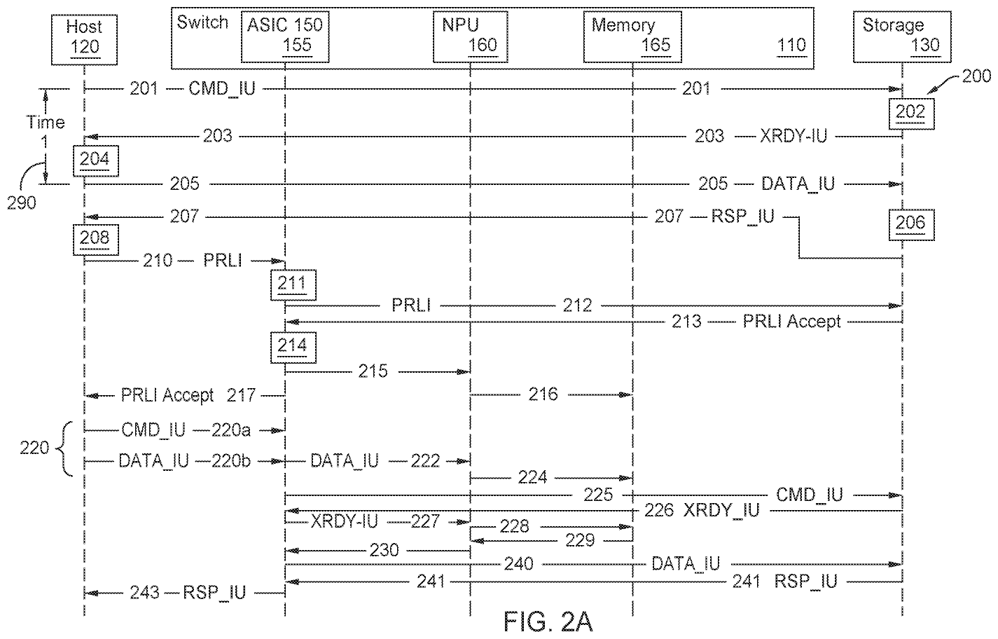

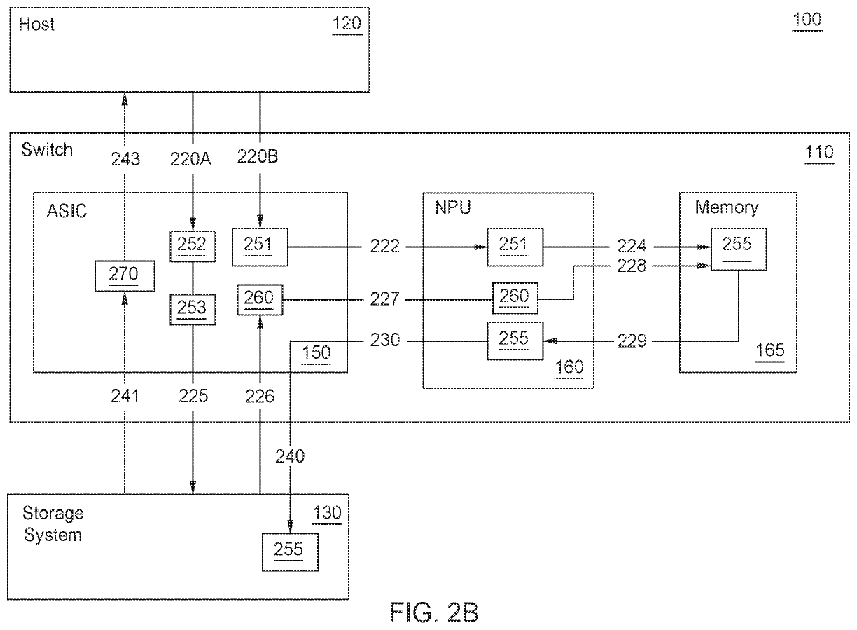

As described above, the FC fabric of the network 100 utilizes a standard set of operations. For example, a standard write I/O operation includes a command sequence with operations including a command (IU) (CMD_IU) from the host 120 and a Transfer Ready IU (XRDY_IU) from the storage system 130. The standard write I/O operation also includes a data sequence, which includes a data IU (DATA_IU) from the host 120, and a response sequence, which includes a response IU (RSP_IU) or storage success frame, from the storage system 130. The standard write I/O operation between the devices in the network 100 is described in more detail in steps 201-208 of method 200 in FIG. 2A.

Additionally, the network 100 also provides for accelerated write I/O operations to provide for fast write operations to available flash media in the storage system 130, including FB write operations. In some examples, the FB write operation is an accelerated write I/O method for FC-NVMe traffic that eliminates the XRDY_IU phase from the standard write I/O operation described above. The elimination of the XRDY_IU phase saves the at least one RTT time for each write operation and reduces overall latency for workloads executing on the host 120.

In some examples, the optimization provided by the FB write operation is most useful for short write I/O operations (e.g., operations of 1 KB or 2 KB). In these short write operations, buffers for receiving the write data at the respective storage systems are allocated in advance (e.g., during a login process and/or before FB operations) and the buffers are dynamically managed at the storage system. In a typical FB write I/O operation, the host sends a write CMD_IU immediately followed by the DATA_IU, without needing to wait for a XRDY_IU from a storage system. This process enables hosts, such as the host 120, to perform large volumes of small write operations at an increased speed related to the standard write I/O operations.

To provide for FB I/O operations to legacy storage devices in the network 100, the switch 110 includes a FB emulation module such as emulator 155. The emulator 155 enables FB I/O operations between the host 120 and the storage system 130 in cases where the storage system 130 does not support FB I/O operations. In some examples, the emulator 155 is an emulation software running on a Data Plane Development Kit (DPDK) framework on a network processing unit (NPU) and implements FB Write emulation.

In some examples, the switch 110 is a first hop switch connected to the storage system 130 (e.g., the connection 145 is a direct connection). In another example the switch 110 is positioned within the network 100 at a distance further than a first hop from the storage system 130. In both examples, the switch 110, via the emulator 155, acts as a proxy for the storage system 130 and emulates the FB behavior to the host 120 on behalf of the storage system 130.

For example, the switch 110 provides for accelerated write operations for host workloads or I/O operations, while also providing standard I/O operations for the storage system workloads. In some examples, the switch 110 includes ASIC architecture such as ASIC 150. In some examples, the switch 110 includes an auxiliary network processing unit (NPU), such as NPU 160, connected to the ASIC 150, and an associated NPU memory, memory 165. In some examples, the emulator 155 executes in software on the NPU 160.

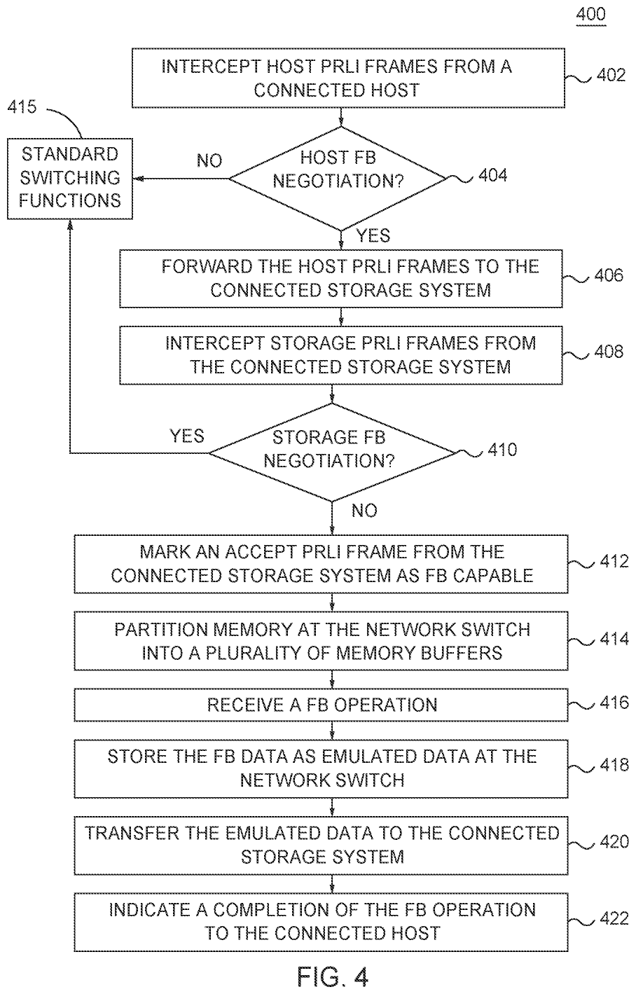

While shown as a separate NPU and NPU memory in FIG. 1, the switch 110 and emulator 155 may utilize any type of processing circuitry and memory to perform the functions described herein. In some examples, the NPU 160 and memory 165 are formatted by the emulator 155 to provide compute and frame buffering functions and emulated FB operations. This formatting includes allocating buffers 166a and 166b as described herein. The process for establishing and utilizing an FB emulation is described in more detail in relation to FIGS. 2A-2B and FIG. 4.

FIG. 2A illustrates a system flow diagram for emulating FB operations, according to one embodiment. FIG. 2B illustrates a system flow block diagram for emulating FB operations, according to one embodiment. For ease of discussion during the description of steps 210-243, reference will also be made to method 400 of FIG. 4 which is a method for emulating FB operations.

As described above, the network 100 provides for both standard I/O operations as well as accelerated I/O operations. A standard I/O operation is illustrated in steps 201-208 of method 200 of FIG. 2A. For example, at step 201, the host 120 sends a CMD_IU to the storage system 130 (via at least the switch 110) to initiate a standard write operation between the host 120 and the storage system 130. In some examples, the CMD_IU indicates a Logical Block address (LBA) location and the length of the data to be written in the storage system 130.

At step 202, the storage system 130, upon receiving the write CMD_IU, allocates sufficient buffers to accept the data that will follow from the host 120. At step 203, the storage system 130 sends a XRDY_IU to the host 120. In some examples, the XRDY_IU indicates a size of buffer allocated for this I/O operation (e.g., the operation initiated by the CMD_IU at step 201) as well as an offset of 0, where the offset marks the beginning of the data buffer. In some examples, the number of buffers allocated by the storage system 130 may be less than or equal to the length of the data specified in the CMD_IU from the host 120.

At step 204 and upon receiving the XRDY_IU, the host 120 initiates DATA_IUs (e.g., using data from applications executing on the host 120, such as application 125) and transmits the DATA_IUs to the storage system 130 at step 205. In some examples, the DATA_IUs are limited to a buffer length specified in the XRDY_IU received at step 203.

At step 206, the storage system 130 receives the DATA_IUs and copies the respective data into the dedicated buffers allocated for this standard write operation. Once all the data for the CMD_IU is received from the host 120, the storage system 130 sends an RSP_IU at step 207, where the RSP_IU indicates the completion of this I/O operation to the host 120. In some examples, when an XRDY is completed with a lesser length than specified in the CMD_IU length, the storage system 130 sends a next XRDY_IU for the next fragment of the data with the offset=previous data size+1. In some examples, the XRDY_IU and DATA_IU sequences in steps 203-205 continue until the data transfer of the write operation is complete.

FC ports or input/output (I/O) ports on the various network devices expect reliable delivery within the no-drop FC fabric of the network 100. The XRDY phase for standard write operations ensures buffer availability to receive data sent from the host 120 with no drops. However, as shown in the steps 201-205, the XRDY phase adds delays equal to time 1 290 in FIG. 2A (e.g., two RTT, buffer allocation, and XRDY generation/processing delays).

In some examples, the network 100 provides the standard operation in steps 201-208 even when FB operations are enabled at the storage system 130 or emulated via the switch 110. For example, the devices in the network 100 implement standard I/O operations when the storage system 130 and/or the switch 110 is experiencing an error that prevents FB I/O operations. Additionally, the devices in the network 100 may utilize the standard I/O operations for large/long write operations.

In another example, some host workloads perform very short write I/O operations such that the additional delay due to XRDY phase would mean an overall higher latency of the I/O operations. For a common edge-core-edge FC-storage area network (SAN) topology of 3 hops between the host and storage, the fabric delay, may be approximately 20 us. Additionally, the XRDY generation/processing delays may add an additional 10 us for every write I/O operation, such that the time 1 290 equals approximately 30 us for the operation. While the FB I/O operations described above reduce these delays in a FC fabric, these FB I/O operations are not possible when the storage system 130 is not capable of FB operations.

In order to enable the FB operations in the network 100, the switch 110 performs enables emulation of the FB operations to the host 120 as described in steps 210-243 of method 200 as well as method 400 of FIG. 4. In some examples, the switch 110 determines whether the host 120 and the storage system 130 support FB I/O operations by intercepting various frames or IUs exchanged between the host 120 and the storage system 130.

At block 402 of the method 400, the switch 110 intercepts host process login (PRLI) frames from a connected host, such as the host 120. For example, as shown in FIG. 2A, the switch 110 (including the emulator 155) intercepts a PRLI frame sent from the host 120 at step 210. In FC fabrics, a capability to perform a FB Write operation is exchanged between a host and a storage system during the PRLI login phase. In a typical FC fabric, a FB Write operation can be performed only if both host and storage support FB mode of operation. In some examples, the NVMeoFC Service parameter page in the PRLI request and the response/accept payload indicates FB support. Additionally, a FB size is also specified by the responding storage device indicating the max number of bytes that may be transmitted from a host to a storage port in one Write I/O operation.

At block 404 and step 211, the switch 110 determines whether the connected host is a FB capable network device by determining FB capability from the host PRLI frames. In one example, the switch 110 intercepts all PRLI frames sent from the host 120 using Access Control Lists (ACLs). A control plane of the switch 110 examines if the host is negotiating for support for FB Writes and FB buffer Size from the PRLI frame. In an example where the PRLI frame from the host 120 is not negotiating FB I/O operations, method 400 proceeds to block 415 and the switch 110 resumes normal FC fabric switching functions.

In an example where the host 120 is negotiating for FB I/O operations, method 400 proceeds to block 406. At block 406, the switch 110 forwards the host PRLI frames to the connected storage system, storage system 130, and intercepts PRLI Accept frames from the storage system 130 at block 408. For example, as shown in method 200 of FIG. 2A, the switch 110 forwards the host PRLI frames to the storage system 130 at step 212. At step 213, the storage system 130 responds to the host 120 with a storage system PRLI frame, where the switch 110 intercepts the PRLI frame from the storage system 130.

At block 410, the switch 110 determines that the connected storage system is not FB capable by determining FB capability from the PRLI Accept frames. For example, a PRLI accept from the storage system 130 may indicate whether the storage port(s) of the storage system 130 supports FB operations. In an example where the PRLI accept indicates that the storage system 130 is FB capable, the method 400 proceeds to block 415 and the switch 110 resumes normal FC fabric switching functions.

When the PRLI accept indicates the storage port of the storage system 130 does not support FB operations, the method 400 proceeds to block 412 and 414 to establish FB emulation for the host 120 at the switch 110. At block 412, the switch 110, including a control plane of the switch 110 marks an PRLI accept frame from the connected storage system as FB capable prior to transmitting the marked PRLI frame to the connected host. For example, at step 214, the switch 110 marks the PRLI accept frame as FB capable, including any indications required for the FB operations such as a size of FB operations allowed from the host 120, and sends the PRLI accept frame to the host 120 at step 217.

At block 414, the switch 110 partitions memory into a plurality of memory buffers based on a plurality of FB operation sizes, such as the size of FB operations indicated in the marked PRLI accept frame sent to the host 120. For example, the switch 110 at step 215, causes the NPU 160 to partition the memory 165 at step 216 into various memory buffers, such as the buffers 166a-b shown in FIG. 1.

Once the host 120 receives the PRLI accept at step 217, the host 120 begins FB write operations (e.g., FB NVMe write) to the storage system 130 at steps 220-243 shown in both FIGS. 2A and 2B. For example, at step 220a the host 120 transmits a CMD_IU 252 and at step 220b transmits a DATA_IU 251, where the CMD_IU 252 and the DATA_IU 251 are intended for the storage system 130.

With the FB emulation active at the switch 110, the method 400 at block 416 includes receiving a FB operation, destined for the connected storage system, which includes a FB write frame and FB data from the host 120. For example, as shown in FIG. 2b, the switch 110 (including the emulator 155) receives the CMD_IU 252 and the DATA_IU 251 from the host 120 at the steps 220a and 220b.

In some examples, the switch 110 rewrites metadata in the FB write frame to indicate a non-FB transfer and forwards the FB write frame to the storage system 130. For example, at step 225 the switch 110 rewrites the CMD_IU 252 into the CMD_IU 253 and forwards the CMD_IU 253 to a storage port of the storage system 130. In some examples, the CMD_IU 253 includes a rewritten FCTL field in a FC header, which indicates a sequence initiative transfer using ACL between the switch 110 (emulating the host 120) and the storage system 130.

At block 418, the switch 110 stores the FB data as emulated data at the network switch. For example, at steps 222, the DATA_IU 251 is captured at the switch 110 using ACLs and forwarded to the NPU 160. At step 224, the NPU 160 stores the DATA_IU 251 as emulated data 255 in a hash table in the memory 165. In some examples, the emulated data 255 is indexed in the memory 165 by SourceID (SID) and DestinationID (DID) along with ExchangeID (OXID) (SID/DID/OXID) of the DATA_IU 251, where every outstanding I/O operation in the network 100 has a unique SID/DID/OXID combination.

At step 226, the storage system 130, processes CMD_IU 253 as a standard write operation including generating and transmitting a XRDY_IU 260 intended for the host 120. At step 226, the switch 110 receives a transfer ready frame, such as the XRDY_IU 260, where the transfer ready frame identifies the emulated data 255 as ready for storage from the storage system 130 and transmits the emulated data to the storage system 130. For example, at step 226, the switch 110 (including a switch port (not shown)) intercepts the XRDY_IU 260 and forwards the XRDY_IU 260 to the NPU 160 at step 227.

At block 420, the switch 110 transfers the emulated data to the connected storage system. In some examples, the XRDY_IU 260 is indexed into a hash table using SID/DID/OXID in the NPU and the corresponding DATA_IU, i.e. emulated data 255, is fetched from memory 165 at step 229. The emulated data 255 is then forwarded to the storage system 130 as a DATA_IU at steps 230 and 240. In some examples, the NPU 160 also drops the XRDY_IU 260 and deletes the associated the hash entry from memory.

At block 422, the switch 110 indicates a completion of the FB operation to the connected host. For example, after the emulated data 255 DATA_IU is written to flash media in the storage system 130, the storage system 130 initiates and transmits RSP_IU 270 to the host 120. The switch 110 receives the RSP_IU 270 at step 241 and passes the RSP_IU 270 along to the host 120 at step 243. The host receiving the RSP_IU 270 at step 243 indicates that the FB Write operation started at step 220 is complete.

During the process described in steps 220-243, the host 120 operates by performing a FB write operation, while the storage system 130 operates by servicing a standard FC write operation. As described above, the switch 110 acts as proxy and emulator including performing any required translations between the FB write operation and the standard FC write operation. For the steps 220-243, the latency of the XRDY_IU phase, represented by time in the steps 201-205, is eliminated since there is no delay between the steps 220a and 220b. Additionally, since the DATA_IU is already available in the NPU 160 as the emulated data 255, a data transfer latency between the storage system 130 and the host 120 is also reduced or eliminated.

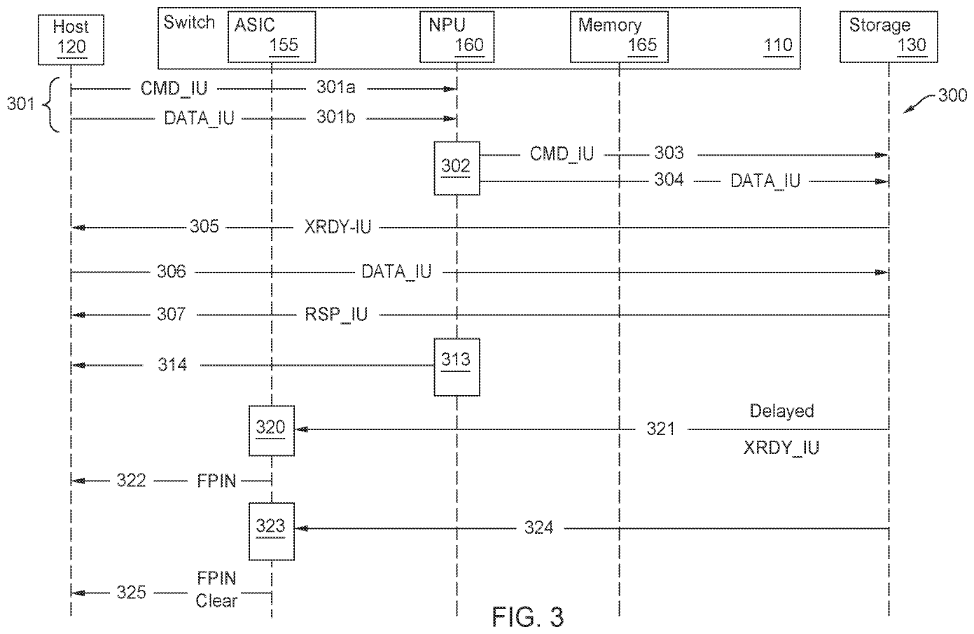

In some examples, the switch 110 provides the FB write operations in steps 220-243 indefinitely or until the associated storage, storage system 130, is updated/upgraded to support FB I/O operations natively. However, in some examples, the switch 110 and/or the storage system 130 may experience network or hardware conditions that require a change or pause in FB emulation as described in more detail in relation to FIGS. 3 and 5-6.

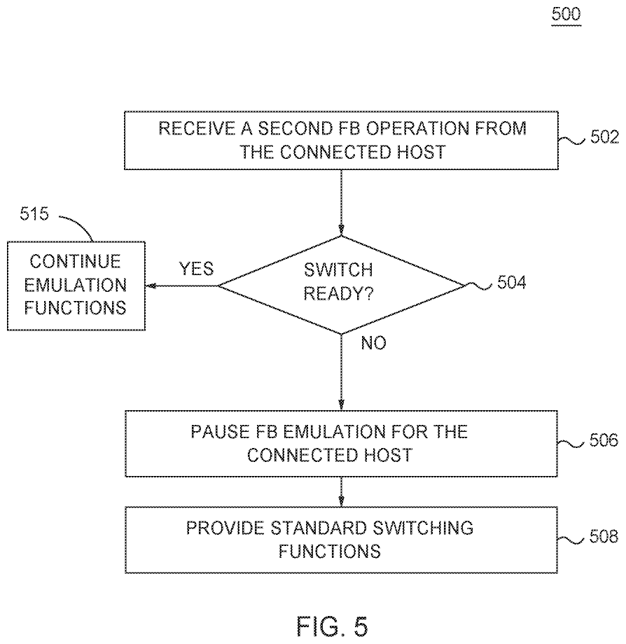

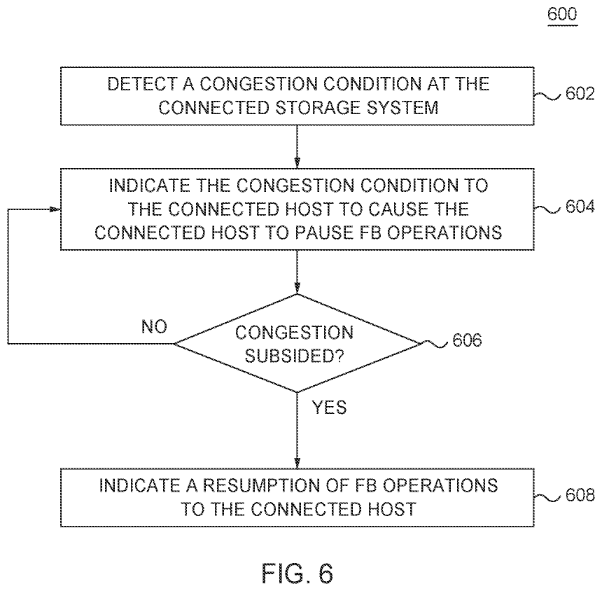

FIG. 3 illustrates a system flow diagram for emulating FB operations, according to one embodiment. FIGS. 5 and 6 are methods for pausing emulated FB operations, according to embodiments. For ease of discussion, reference will be made to method 500 of FIG. 5 and method 600 of FIG. 6 throughout the discussion of method 300 of FIG. 3.

Method 300 begins at step 301 where the host 120 initiates a FB operation including sending a FB CMD_IU at step 301a and a DATA_IU at step 301b. Method 500 begins at block 502 where the switch 110 receives a second FB operation from the connected host, such as the host 120. For example, at steps 301a and 301b, the switch receives a FB CMD_IU and DATA_IU from the host 120.

At block 504, the switch 110 determines whether the NPU is ready for the second FB operation. When the NPU 160 is ready for additional FB operations, method 500 proceeds to block 515 where the switch 110 continues emulation functions. In another example, the NPU 160 is not ready when then NPU 160 does not have sufficient memory to complete a FB I/O operation (e.g., NPU Buffer exhaustion) or when the NPU 160 is in a reset protocol.

Referring to FIG. 3, at step 302, the NPU assesses a current NPU state to determine FB capability. In one example, the NPU may have low accessible memory in the memory 165 due to a large number of I/O operations at the switch 110. For example, the memory 165 may not have available buffers to hold new or additional DATA_IUs. In another example, the NPU 160 may be in a reset protocol (e.g., performing software upgrades) and thus not available for FB I/O operations.

At block 506, the switch 110 pauses FB emulation for the connected host and provides standard switching functions for storage functions between the connected host and the connected storage system at block 508. The CMD_IU received at step 301a is provided to the storage system 130 at step 303. At step 304, the NPU 160 forwards the DATA_IU received at step 301b and deletes/pauses any ACLs that intercept future DATA/XRDY frames at the switch 110.

Additionally, the storage system 130 discards the CMD_IU received at step 304 and at step 305, the XRDY in response to the WRITE is received by the host 120. In some examples, the receipt of the XRDY at the host 120 is equivalent to a FB DATA discard case and the host 120 will resend the DATA_IU again as part of a standard write operation at steps 306 and 307, where these operations are similar to those described in steps 201-207 of FIG. 2A. In this example, the switch 110 performs only pure switching functions for the standard I/O operations. In some examples, once the buffer availability improves to allow for FB operations, the NPU 160 updates ACLs at the switch 110 to restart the FB emulation at step 313. The switch 110 then indicates the resumption FB operations to the host 120 at step 314.

Another condition for pausing FB emulation at the switch 110 may be caused by congestion at the storage system 130. Method 600 begins at block 602 where the switch 110 detects a congestion condition at the connected storage system. For example, when a storage port at the storage system 130 is busy, the storage system 130 may delay sending an XRDY_IU at step 321. This delay is detected at the switch 110 at step 320. In some examples, the NPU 160 does not have sufficient processing and memory resources to hold all the operation data in buffers during this delay due to limited memory on the switch 110 and thus will need to mitigate some of the workloads on the switch.

At block 604, the switch 110 indicates the congestion condition to the connected host to cause the connected host to pause FB operations. In some examples, the storage system 130 sends a Fabric Performance Impact Notification (FPIN) Peer Congestion Notification to the host 120 with Event=Resource Contention. In another example where the storage system 130 is not FPIN capable, the switch 110, at step 322, sends the FPIN based on its buffer occupancy and a TxWait condition detected on a storage edge port of the switch 110. In both examples, the host 120 implements a slow down or suspension of FC I/O operations, including FB write operations.

At block 606, the switch 110 detects the congestion condition has subsided and indicates a resumption of FB operations to the connected host at block 608. For example, once the congestion subsides at steps 323 and step 324 in FIG. 3, the storage system 130 and/or the switch 110 sends a FPIN Peer Congestion with Clear at the step 325, indicating that the host 120 may resume its full rate of FB write operations.

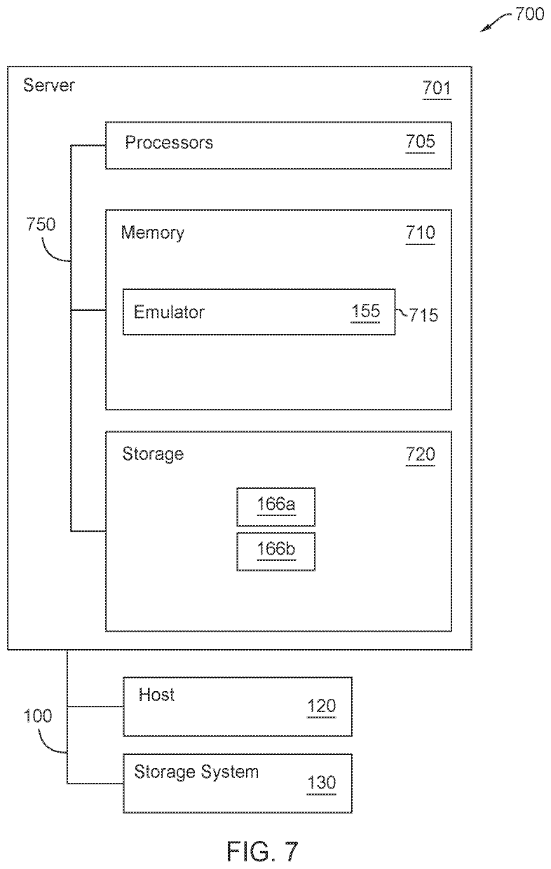

FIG. 7 illustrates a block diagram of a network switch, according to one embodiment. The arrangement 700 may include a switch embodied as server/computer/router or other networked devices which executes the functions of the switch 110 shown in FIG. 1, and perform the methods described herein. The switch 701 is shown in the form of a general-purpose computing device. The components of switch 701 may include, but are not limited to, one or more processing units or processors 705, a system memory 710, a storage system 720, a bus 750 that couples various system components including the system memory 710 and storage system 720 to processors 705 along with an external network interface and input/output interface. In some embodiments, arrangement 700 is distributed and includes a plurality of discrete computing devices that are connected through wired or wireless networking.

System memory 710 may include a plurality of program modules, modules 715, for performing various functions related to connecting a user device to a protected network, described herein. The modules 715 generally include program code that is executable by one or more of the processors 705. As shown, modules 715 include the emulator 155. In some examples, the modules 715 may be distributed and/or cloud based applications/modules. Additionally, storage system 720 may include media for storing buffers 166a and 166b, and other information. The information stored in storage system 720 may be updated and accessed by the modules 715 described herein.

Additionally various computing components may be included to perform the methods described herein. For example, bus 750 represents one or more of any of several types of bus structures, including a memory bus or memory controller, a peripheral bus, an accelerated graphics port, and a processor or local bus using any of a variety of bus architectures. In some examples, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Further, switch 701 typically includes a variety of computer system readable media. Such media may be any available media that is accessible by switch 701, and it includes both volatile and non-volatile media, removable and non-removable media.

System memory 710 can include computer system readable media in the form of volatile memory, such as random access memory (RAM) and/or cache memory. Switch 701 may further include other removable/non-removable, volatile/non-volatile computer system storage media. In some examples, storage system 720 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 750 by one or more data media interfaces.

As depicted and described above, system memory 710 may include at least one program product having a set (e.g., at least one) of modules 715 that are configured to carry out the functions of embodiments of the invention. Switch 701 may further include other removable/non-removable volatile/non-volatile computer system storage media. In some examples, storage system 720 may be included as part of system memory 710 and may typically provide a non-volatile memory for the networked computing devices, and may include one or more different storage elements such as Flash memory, a hard disk drive, a solid state drive, an optical storage device, and/or a magnetic storage device.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium, such as a non-transitory computer readable medium, that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
determining, at a network switch, a connected host, connected to the network switch, is a first burst (FB) capable network device;
establishing an FB emulation for the connected host at the network switch upon determining a connected storage system, connected to the network switch, is not FB capable;
receiving a FB operation comprising a FB write frame and FB data from the connected host destined to the connected storage system;
storing the FB data as emulated data at the network switch;
transferring the emulated data to the connected storage system; and
indicating a completion of the FB operation to the connected host.

2. The method of claim 1, wherein the emulated data is stored in a network processing unit (NPU) on the network switch, and wherein the NPU is formatted to provide compute and frame buffering functions for the network switch.

3. The method of claim 2, further comprising:
receiving a second FB operation from the connected host;
determining the NPU is not ready for the second FB operation, wherein the NPU is not ready when then NPU does not have sufficient memory to complete the second FB operation or when the NPU is in a reset protocol;
pausing the FB emulation for the connected host; and
providing standard switching functions for storage functions between the connected host and the connected storage system.

4. The method of claim 1, further comprising:
detecting a congestion condition at the connected storage system;
indicating the congestion condition to the connected host to cause the connected host to pause FB operations;
detecting the congestion condition has subsided; and
indicating a resumption of FB operations to the connected host.

5. The method of claim 1, further comprising:
intercepting host process login (PRLI) frames from the connected host;
wherein determining the connected host is a FB capable network device comprises determining FB capability from the host PRLI frames;
forwarding the host PRLI frames to the connected storage system;
intercepting PRLI Accept frames from the connected storage system; and
wherein determining the connected storage system is not FB capable comprises determining FB capability from the PRLI Accept frames.

6. The method of claim 5, wherein establishing the FB emulation comprises:
marking a PRLI accept frame from the connected storage system as FB capable prior to transmitting the marked PRLI accept frame to the connected host; and
partitioning memory at the network switch into a plurality of memory buffers based on a plurality of FB operation sizes, wherein the marked PRLI accept frame indicates a size of FB operations allowed from the connected host.

7. The method of claim 1, wherein storing the emulated data in the connected storage system comprises:
rewriting metadata in the FB write frame to indicate a non-FB transfer;
forwarding the FB write frame to the connected storage system;
receiving a transfer ready frame identifying the emulated data as ready for storage from the connected storage system;
transmitting the emulated data to the connected storage system;
receiving a storage success frame from the connected storage system; and
wherein indicating the completion of the FB operation to the connected host comprises forwarding the storage success frame to the connected host.

8. A system comprising:
a processor; and
a memory comprising instructions which, when executed on the processor, performs an operation, the operation comprising:
determining, at a network switch, a connected host is a first burst (FB) capable network device;
establishing an FB emulation for the connected host at the network switch upon determining a connected storage system, connected to the network switch, is not FB capable;
receiving a FB operation comprising a FB write frame and FB data from the connected host;
storing the FB data as emulated data at the network switch;
transferring the emulated data to the connected storage system; and
indicating a completion of the FB operation to the connected host.

9. The system of claim 8, where the emulated data is stored in a network processing unit (NPU) on the network switch, wherein the NPU is formatted to provide compute and frame buffering functions for the network switch.

10. The system of claim 9, wherein the operation further comprises:
receiving a second FB operation from the connected host;
determining the NPU is not ready for the second FB operation, wherein the NPU is not ready when then NPU does not have sufficient memory to complete the second FB operation or when the NPU is in a reset protocol;
pausing the FB emulation for the connected host; and
providing standard switching functions for storage functions between the connected host and the connected storage system.

11. The system of claim 8, wherein the operation further comprises:
detecting a congestion condition at the connected storage system;
indicating the congestion condition to the connected host to cause the connected host to pause FB operations;
detecting the congestion condition has subsided; and
indicating a resumption of FB operations to the connected host.

12. The system of claim 8, wherein the operation further comprises:
intercepting host process login (PRLI) frames from the connected host;
wherein determining the connected host is a FB capable network device comprises determining FB capability from the host PRLI frames;
forwarding the host PRLI frames to the connected storage system;
intercepting PRLI accept frames from the connected storage system; and
wherein determining the connected storage system is not FB capable comprises determining FB capability from the PRLI Accept frames.

13. The system of claim 8, wherein establishing the FB emulation comprises:
marking a PRLI accept frame from the connected storage system as FB capable prior to transmitting the marked PRLI accept frame to the connected host; and
partitioning memory at the network switch into a plurality of memory buffers based on a plurality of FB operation sizes, wherein the marked PRLI accept frame indicates a size of FB operations allowed from the connected host.

14. The system of claim 8, wherein storing the emulated data in the connected storage system comprises:
rewriting metadata in the FB write frame to indicate a non-FB transfer;
forwarding the FB write frame to the connected storage system;
receiving a transfer ready frame identifying the emulated data as ready for storage from the connected storage system;
transmitting the emulated data to the connected storage system; and
receiving a storage success frame from the connected storage system; and
wherein indicating the completion of the FB operation to the connected host comprises forwarding the storage success frame to the connected host.

15. A computer program product comprising a non-transitory computer-readable medium having program instructions embodied therewith, the program instructions executable by a processor to perform an operation comprising:
determining, at a network switch, a connected host is a first burst (FB) capable network device;
establishing an FB emulation for the connected host at the network switch upon determining a connected storage system, connected to the network switch, is not FB capable;
receiving a FB operation comprising a FB write frame and FB data from the connected host;
storing the FB data as emulated data at the network switch;
transferring the emulated data to the connected storage system; and
indicating a completion of the FB operation to the connected host.

16. The computer program product of claim 15, wherein the emulated data is stored in a network processing unit (NPU) on the network switch, wherein the NPU is formatted to provide compute and frame buffering functions for the network switch wherein the operation further comprises:
receiving a second FB operation from the connected host;
determining the NPU is not ready for the second FB operation, wherein the NPU is not ready when then NPU does not have sufficient memory to complete the second FB operation or when the NPU is in a reset protocol;
pausing the FB emulation for the connected host; and
providing standard switching functions for storage functions between the connected host and the connected storage system.

17. The computer program product of claim 15, wherein the operation further comprises:
detecting a congestion condition at the connected storage system;
indicating the congestion condition to the connected host to cause the connected host to pause FB operations;
detecting the congestion condition has subsided; and
indicating a resumption of FB operations to the connected host.

18. The computer program product of claim 15, wherein the operation further comprises:
intercepting host process login (PRLI) frames from the connected host;
wherein determining the connected host is a FB capable network device comprises determining FB capability from the host PRLI frames;
forwarding the host PRLI frames to the connected storage system;
intercepting PRLI accept frames from the connected storage system; and
wherein determining the connected storage system is not FB capable comprises determining FB capability from the PRLI Accept frames.

19. The computer program product of claim 15, wherein establishing the FB emulation comprises:
marking a PRLI accept frame from the connected storage system as FB capable prior to transmitting the marked PRLI accept frame to the connected host; and
partitioning memory at the network switch into a plurality of memory buffers based on a plurality of FB operation sizes, wherein the marked PRLI accept frame indicates a size of FB operations allowed from the connected host.

20. The computer program product of claim 15, wherein storing the emulated data in the connected storage system comprises:
rewriting metadata in the FB write frame to indicate a non-FB transfer;
forwarding the FB write frame to the connected storage system;
receiving a transfer ready frame identifying the emulated data as ready for storage from the connected storage system;
transmitting the emulated data to the connected storage system;
receiving a storage success frame from the connected storage system; and
wherein indicating the completion of the FB operation to the connected host comprises forwarding the storage success frame to the connected host.
